(19) United States
(12) Patent Application Publication
(10) Pub. No.: US 2004/0215468 A1
(43) Pub. Date: Oct. 28, 2004

(54) SYSTEM AND METHOD FOR MANAGING BUSINESS MACHINE ASSETS

(76) Inventors: Terrence M. Doeberl, West Redding, CT (US); Paul Ernest Duedall, Palm Bay, FL (US); Mark E. Hogan, Melbourne Beach, FL (US); John D. Goldson, Palm Bay, FL (US)

Correspondence Address: PITNEY BOWES INC., 35 WATERVIEW DRIVE, P.O. BOX 3000, MSC 26-22, SHELTON, CT, 06484-8000, US

(21) Appl. No.: 10/249,613

(22) Filed: Apr. 23, 2003

(51) Int. Cl. G06F 17/60

(52) U.S. Cl. 705/1

(57) ABSTRACT

Systems and methods for managing business machine assets are described. In one configuration, the system manages consumable usage including predicting usage, predicting replacement times, monitoring consumables fraud and providing consumable usage reports. Business machine usage data is used to predict expected consumables usage. The expected consumables usage is then compared to actual consumables usage in order to determine compliance. In another configuration, the system manages service and maintenance issues including trends and compliance.

### CROSS REFERENCE TO RELATED APPLICATIONS

This application is related to commonly assigned, co-pending U.S. patent application Ser. No. ______: Not Yet Assigned, filed on even date herewith, entitled “SYSTEM AND METHOD FOR DYNAMICALLY MANAGING BUSINESS MACHINE ASSET LOCATION,” in the name of Terrence M. Doeberl, Paul Ernest Duedall, Mark E. Hogan and John D. Goldson, assigned attorney docket number F-681, the disclosure of which is hereby incorporated by reference in its entirety.

### BACKGROUND OF INVENTION

The illustrative embodiments described in the present application are useful in systems including those for managing assets and more particularly are useful in systems including those for managing asset lifecycle for an enterprise including procurement, tracking and assignment, service, activity, billing and reporting for assets such as fleets of business machines including copiers, printers and mailing machines. Many companies purchase business machines such as output devices including printers in a haphazard fashion in which users request printers from the Information Technology (IT) department. The company may have an IT budget per organization, but may not study organization usage and life cycle management. Such strategies are based upon individual need at a point in time and may not consider changes to those needs over time and when making future purchase decisions. In such environments, half of the output devices may be underutilized and a quarter may be over-utilized.

Companies typically spend between one and three percent of gross revenue on printing costs. About 20 percent of that cost includes office printing, copying and faxing. A company may have one printer per 4 employees and one copier per 50 employees. Progressive cost-conscious companies may perform a static rightsizing analysis in which output devices are strategically distributed across the enterprise. Such static analysis may be expensive to complete and require productivity savings over time to produce a return on investment for the analysis.

Certain companies utilize capital asset management software applications such as those available from Peregrine or Main Control. Such systems may not support usage recording or user-based cost accounting. Additionally, such systems may not support management of many client fleets using either an on-site decentralized basis or a centralized, cross-client basis.

### SUMMARY OF INVENTION

The present application describes systems and methods for managing assets. In at least one embodiment, the asset management system supports outsourced management of many client fleets on either an on-site, decentralized basis or on centralized, cross-client bases. The system manages consumable usage including predicting usage, predicting replacement times, monitoring consumables fraud and providing consumable usage reports. In another embodiment, the system manages service and maintenance issues including trends and compliance.

In another embodiment, the above functions are included in a comprehensive system including a system for asset management supporting equipment procurement, physical movement, financial movement, service management, activity tracking, equipment utilization analysis and optimization, usage meter reading, usage data collection, multiple pricing/billing model support and detailed customer and internal management reporting. In at least one embodiment, the asset management system provides for integration with third party e-commerce and networked device output data collection systems in order to streamline both equipment and supplies procurement processes and to automate usage data collection.

### BRIEF DESCRIPTION OF DRAWINGS

FIG. 1 is a schematic representation of an illustrative system including representative components including business machines and Asset Management systems according to an illustrative embodiment of the present application.

FIG. 2 is a schematic representation of a data record relating to consumables in an Asset Management system according to an illustrative embodiment of the present application.

FIG. 3 is a flow chart showing a process for detecting the presence of consumables fraud according to an illustrative embodiment of the present application.

FIG. 4 is a flow chart showing a process for identifying under-performing vendors or key operators according to an illustrative embodiment of the present application.

FIG. 5 is a flow chart showing a process for identifying under-performing vendors or key operators according to an illustrative embodiment of the present application.

### DETAILED DESCRIPTION

Certain companies outsource printer, copier and other business machine operations. For example, certain companies hire an outsource provider to manage a fleet of business machines. Business machines include copiers, facsimile machines, printers, multifunction machines, scanners, computers, mailing machines and other devices. The management may include procurement, maintenance and all life cycle management issues. The customer may purchase the business machines. Additionally, the customer may lease equipment from the management intermediary or may allow the intermediary to manage leases with equipment vendors and service agreements with maintenance providers. Similarly, the managing intermediary may be responsible for supplies. Output device acquisition options include purchase, lease, click-charge and usage-based solutions. Certain output device manufacturers offer usage based solution packages based upon the use of that companies output devices, supplies and service. Consumables may be optional. Certain other companies may integrate competitor products that existed at the client site when the usage-based solution was implemented.

Accordingly, it may be disadvantageous to utilize inaccurate and labor intensive manual accounting processes for usage and device tracking, particularly when managing larger dynamically changing fleets of business machine assets.

In at least one embodiment, the asset management system supports outsourced management of many client fleets so that consistent business processes and standards may be applied across a broad client base in a cost effective manner on either an on-site, decentralized basis or on centralized, cross-client bases. The system provides for automatically tracking the entire asset lifecycle and for recording all actions taken in managing the asset. The system manages equipment procurement, physical movement, financial movement, service management, activity tracking, equipment utilization analysis and optimization, print/copy usage meter reading, usage data collection, multiple pricing/billing model support and detailed customer and internal management reporting. In at least one embodiment, the asset management system provides for integration with third party e-commerce and networked device output data collection systems in order to streamline both equipment and supplies procurement processes and to automate usage data collection.

In at least one embodiment, the Asset Management System comprises at least one Dell server using Microsoft SQL 2000 relational database software, Crystal Reports from Seagate and code written in Borland Delphi. The Asset Management System is a software system designed to manage all aspects of output device fleet management for large corporations. The client system is a thick client application that interacts with a server executing the Asset Management System for a group of clients. Alternatively, a thin client may be utilized incorporating a Java interface. The server is centralized and may be load balanced. The server may utilize a separate database for each client, or may utilize a single database for multiple clients. Alternatively, the server may be on-site for a customer, near site at a site nearby the customer site or remote. Alternatively, a client may have a private version of the Asset Manager.

The Asset Management System integrates a call center function, asset tracking function, contract tracking, compliance and planning function, a cost function, a tax function, consumables tracking and compliance function and a service level function.

Database.

In at least one embodiment, the Asset Manager System maintains a database using Microsoft SQL 2000 that includes device parameters for a client site. For example, each asset is assigned a primary key named the asset tag that is unique across the entire universe of managed systems. Consequently, the Asset Manager System can export data to another system such as a billing system without requiring a second key to uniquely identify an asset. Alternatively, the Asset Manager System provides an asset tag that is only unique for a particular customer or site and then uses additional keys such as the customer identifier to identify the asset. Alternatively, the database may utilize device serial number to identify an asset in conjunction with other keys. As it is possible that a business machine vendor may not issue unique serial numbers, the system can ensure unique identification of a business machine by assigning a unique identifier to each business machine. Since the system may be distributed, techniques for ensuring the uniqueness of asset tags may include a centralized issuing authority or an asset tag that incorporates information unique to a site such as a customer identifier. The unique identifier may incorporate client data or even manufacturer data such as a manufacturer identifier or number.

The database includes a hierarchal location structure for the business machines so that geographic information can be considered. The customer, site, building, floor and room number or other location data is included in the database. Furthermore, an organizational tree is included in the database so that particular departments or users can be identified in relation to the hierarchal location structure. The physical and departmental organization for a site, campus and enterprise level of a customer organization can be stored and viewed using a Graphical User Interface (GUI). The database maintains such physical location information and also maintains financial information. For example, the database stores data for charging back expenses. A department may be responsible for the cost or two or more departments may apportion the costs.

Data Input.

The Asset Manager may acquire data while performing functions such as procurement management. In such cases, data regarding the asset is captured during procurement. Certain asset data may be input during a new client import. For example, data relating to existing assets may be entered into the system. In one embodiment, Microsoft Excel templates are utilized to capture device parameters. For example, a Microsoft Excel template may be generated periodically and may be generated according to the physical locations of devices along a route such as an internal mail delivery route. Accordingly, mail delivery personnel can capture business machine usage data while delivering mail using a template that lists the machines in the order that they are encountered along the route. A machine may include multiple meters that may distinguish between parameters such as color and monochrome pages printed. If a machine is moved, the template is redefined. Thereafter, a data entry operator transcribes the data into the system. Known techniques such as redundant data entry operations can be used to ensure accuracy. Data files created using the templates may be transported using email or other known file transfer methods. They may then be uploaded into the Asset Manager database.

Consumable usage may similarly be tracked using a template. The mail delivery personnel could take toner inventory and enter the data on the template form. Alternatively, the consumable usage may be separately recorded by a technician periodically such as daily from a log carried during toner change calls. In an alternative, the data input technician is issued a handheld computer such as a PDA with wireless connectivity and a bar code reader. The business machines at the site have an asset tag bar code or other identifier that is used to identify the business machine. The data input technician, scans the asset bar code tag and the PDA requests information pertinent to that machine, such as the meter reading for a copier. In another alternative, the PDA informs the technician whether data is required for a particular business machine along a known route such as the internal mail delivery route.

In another alternative, a machine Management Information Base (MIB) is captured that includes usage information, an error log, a make, model and serial number and a rolling meter count of pages printed. The device may have another unique identifier such as a network MAC address.

In another alternative, data input is captured from business machine accounting systems such as those available from Equitrax. In such systems, the Asset Manager may capture client/matter or department utilization as well. For example, department utilization is cross-referenced with device geographical information in a report. Additionally, in such an alternative, the department charge-back information may be based upon actual click counts rather than a preset percentage.

Toner Yield.

The Asset Manager System calculates toner yield based upon the usage meter readings and toner change records in order to determine whether a particular asset met the anticipated toner yield. If the toner yield is not met, a report is generated and the site manager may decide to make a claim for a refund from the toner manufacturer. The system maintains manufacturer data and distributor data so that manufacturer trends, distributor or lot trends may be tracked.

Child Assets.

The Asset Manager System can capture and track child assets as they are moved from parent to parent or added to a parent. For example, a computer may have a faulty disk drive that is swapped. The parent asset tracking number may be associated with child asset numbers that may be changed over time.

Meter Estimates and Extrapolation.

The Asset Manager System provides the ability to estimate meter readings and may utilize configurable contract rules for the calculation. For example, an average monthly usage over the prior three months may be used as an estimate.

Consumables Monitoring.

Several systems for monitoring consumable supply levels and ordering consumable supply replacements have been described. For example, U.S. Pat. No. 5,305,199 entitled Consumable Supplies Monitoring/Ordering System for Reprographic Equipment issued to LoBiondo, et al. on Apr. 19, 1994. U.S. Pat. No. 6,275,664 B1 entitled Predicting Supplies Required for Completion of Unattended Print Jobs issued to Wolf, et al. on Aug. 14, 2001. U.S. Pat. No. 6,529,692B1 entitled Consumable Order-Assistance System for Computer Peripheral Device Within a Single Connection Environment and Method for Replenishing Consumables issued to Haines, et al. on Mar. 4, 2003. The above referenced patent documents are incorporated herein by reference in their entirety. Such systems attempt to assist in determining when supplies need to be ordered.

However, consumables may be removed from local stockpiles without authorization. For example, reams of paper or toner cartridges may be expropriated from the supply storage areas or ordered more frequently than actually used. Additionally, a particular customer may purchase only a percentage of consumables from the business machine asset management company.

In at least one embodiment, the Asset Manager compiles current and historical usage data for each asset being managed. The system also obtains consumable data such as information relating to when each toner is changed and the type of the toner. Other consumables such as paper, fusers, and drums can be tracked.

In another embodiment, the system considers location information and nearby like device information. Certain devices including those with the same or similar model numbers use the same consumables such as toner.

An illustrative method to trend and predict output device consumable usages within a localized site, campus, or enterprise environment is described. The Asset Management System maintains information regarding all output device models used within the customer's environment, including the type of consumables used. The system maintains information relating to the consumables used with each of these models. For example, acceptable consumables from several manufacturers may be applicable. Furthermore, consumables such as toner cartridges may be available with different amount of toner included. For example, a particular printer may be available with a toner rated at 5,000 pages or 10,000 pages. The predicted capacity of each consumable is typically based on the amount of pages (per-page or clicks) that can be successfully processed. Such predictions are typically based upon models of typical toner coverage per page over a set or subset of document types. Of course, the actual document page coverage printed will affect the actual toner usage. Certain users will have usage patterns that differ widely from the computed predicted values of toner usage.

The system also provides a Consumable Module to maintain the consumable purchases for each asset. The system may also maintain a consumable inventory for an asset or group of assets. The inventory may be based upon location as well and may include an enterprise or subset of an enterprise such as a department.

Additionally, consumable requests can be managed through the Incident Module that tracks service and maintenance calls.

For a customer that does not manage consumables through the system, the Asset Manager can predict the amount of consumables that the customer should be using and provide a report of such predicted usage. A salesperson may then use those reports in an attempt to sell consumables to the customer. Using the previously defined historical device usages, the system can trend the predicted consumable usage with the actual consumable purchases. For example, a customer may be purchasing only a percentage of consumables from the business machine asset management company.

The consumable data may be organized by model type, consumable type, department or other organizational group or floor or other location set. Accordingly, the system provides for Identification and trending of consumable purchases for specific devices or models as well as Identification and trending of consumable purchases to specific physical locations. The consumables data including consumables purchases can be related to a physical location hierarchy or on a site or enterprise basis.

In an alternative, certain customers pay for business machine services purely by pages printed or other metrics. In such cases, all required consumable may be included in the customer contract. Accordingly, the Asset Manager system tracks the cost of consumables used to enable efficient management of consumable purchases to contracts by providing relevant reports. The contract price may be adjusted if an extraordinary amount of consumables are used.

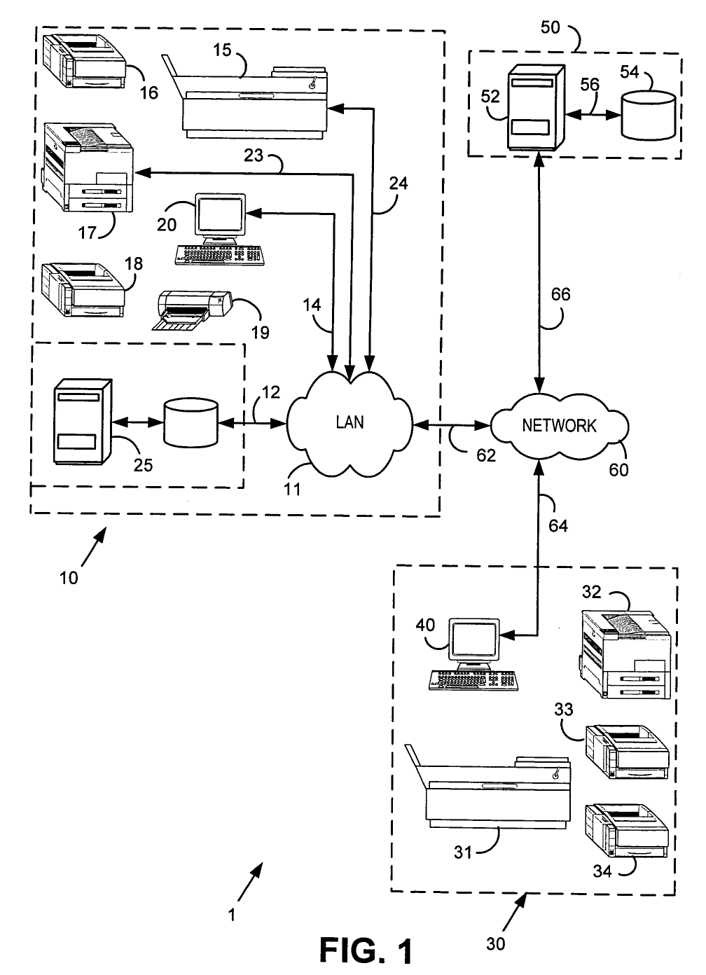

With reference to FIG. 1, an illustrative system for managing assets 1 is described. A first representative customer system 10 having illustrative components includes a Local Area Network 11 that is connected to a local Asset Manager Server 25 by Ethernet communications channel 12. Typical communications systems and channels are used and appropriate security measures are taken. Copier 15 is connected to the LAN 11 using communications channel 24. Group printer 17 is connected to the LAN 11 using communications channel 23. An Asset Manager client 20 is a Dell Pentium 4 PC connected to the LAN using communications channel 14. Alternatively, other computers and peripherals may be utilized. Standalone laser printers 16 and 18 are representative of printers at the customer site. They are the same model type and are located on the same floor but in different departments of the customer organization. The customer also utilizes Standalone ink jet printer 19. The devices include location and department information.

The first customer system 10 is connected to network 60 using T1 communications channel 62. The network 60 is the Internet. Alternatively, other networks may be utilized.

Centralized Asset Manager system 50 includes a server 52 with storage 54 connected locally by communications channel 56. The server includes a Dell server running Microsoft SQL 2000. Alternatively, the storage is remote and a Unix platform is utilized. The Asset Manager Server 50 is connected to the Network 60 using communications channel 66.

A second representative customer system 30 includes illustrative components. Asset Manager client 40 is connected to the network 60 using communications channel 64. Group printer 32 is a standalone unit as are personal laser printers 33 and 34. Copier 31 is available at the customer site and is also standalone. The devices are located in order 31, 32, 33 and 34 along the mail delivery path for the respective floor at the customer site 30.

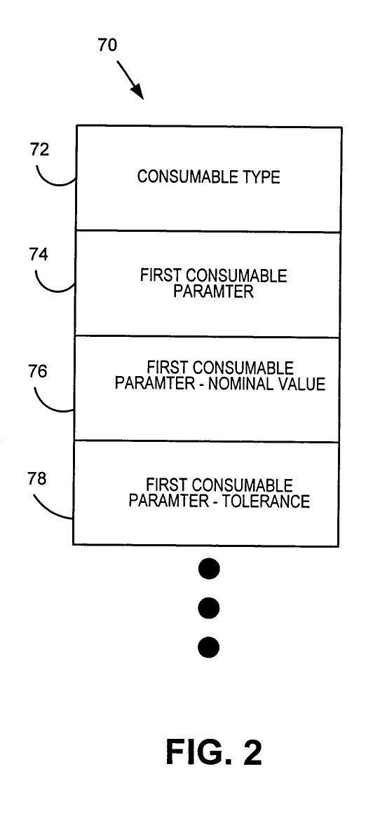

With reference to FIG. 2, a data record used to trend and predict output device consumable usage is described. A consumable type record 70 includes a consumable type identifier 72 and one or more consumable parameters 74 such as toner amount, target number of page life, low number of page life and high number of page life. The parameter 74 will include a nominal value 76 and tolerance information 78. Additional parameters may be used. Alternatively, a tolerance range may be specified as a percentage or an acceptable range without a target may be specified.

Typical consumable types include many models each of toner, fuser, developer, drum, photo conductor, roller, staples, transfer assemblies, ribbon, ink cartridges, waste recycle containers and sometimes paper.

The consumable types will have associated attributes. For example, a toner cartridge will include a target number of pages and utilization data. The target may also include a tolerable range or percentage tolerance.

A typical toner cartridge for black toner may nominally print 10,000 pages, but have a tolerance of 7,000 through 12,000 pages. Accordingly, if toner usage was not consistent with the meter reads for number of pages printed, a potential fraud flag is asserted.

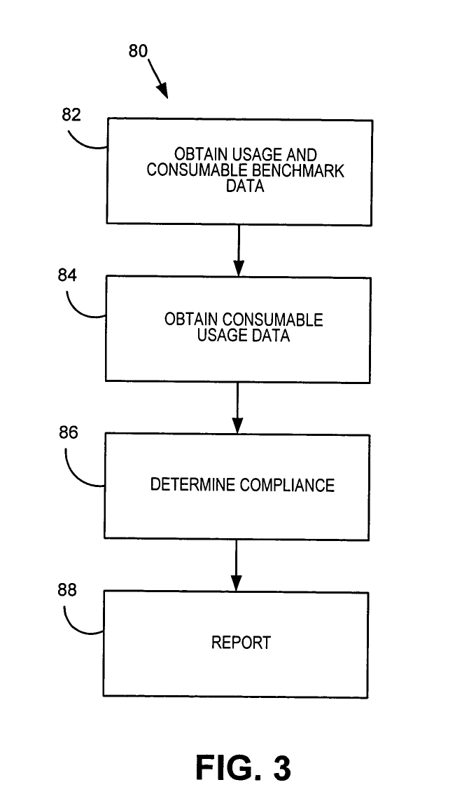

With reference to FIG. 3, an illustrative method to trend and predict output device consumable usage is described.

The consumables monitoring process 80 begins. The user may run the process in a batch mode to process reports or it may be a background process that pushes exception data out to the operator when encountered. In step 82, the process obtains current and historical meter readings or other usage data for the business machine or group of machines under consideration along with benchmark consumable data. The user may select many asset groups including a group of all of one asset type, a group of all asset types using a particular consumable type, a group based upon location criteria such as a particular customer site or floor, a group based upon organizational based criteria such as a department or an individual asset.

In step 84, the process obtains information relating to the consumable replenishments such as when the toner of a printer was last changed. The data may be obtained from an Asset Manager purchasing module, an incident help desk module, by manual inventory or other method. Alternatively, inventory data regarding remaining consumables can be input and compared to historical usage data. In step 86, the process determines whether the consumable usage is within tolerance. This compliance step may take into account other factors as discussed below. If not, the process reports the discrepancy in step 88. The reporting step may withhold notification and track potential consumables fraud over time until a confidence level such as 40% out of tolerance or more is reached.

For example, a monochrome group laser printer uses black toner has an expected toner life of 10,000 pages with a tolerance of 10%. During January, 100,000 pages were printed and 14 toner cartridges were ordered. Accordingly, 14 toner cartridges should print at least 9,000 times 14 or 126,000 minimum pages. The usage here is out of tolerance and would be flagged. If the usage was within 10 percent, it would not be flagged, but an aggregated period of two months would later be used to obtain more accurate usage data over a larger statistical sampling. Alternatively, another printer may have printed 100,000 pages, but had only 6 toner cartridges ordered. Such a discrepancy would also be reported. In an alternative, the two printers in question would offset discrepancies and no discrepancy would be reported. In another alternative, potential matching discrepancies such as one printer over consumables and one nearby printer under will be reported. The user can then decide whether an investigation is necessary.

In another alternative, a group of machines are considered together. The group may include the same types of printers on a floor that are in a pool for supplies.

If supplies are determined to be missing for a device or group of devices, it is possible that they were moved or utilized in another area. Accordingly, the system also reports potential excess supply inventories. For example, if a printer on a particular floor appears to have not consumed one of the toner cartridges allocated to it, the system may search for a printer on the same floor that appears to have used one less toner than allocated. The report may list the two incidents side by side to determine if they match. The system may also list charge back data for each of the two devices so that a determination can be made whether a charge back department-to-department adjustment should be made.

Similarly, an outsourcing company may wish to track consumables to determine if outside or unauthorized consumables are being utilized. Accordingly, reporting step 88 may be the only step used and it may be used to report predicted usage to a salesperson for follow-up. If a location-based algorithm is used, the system utilizes location information to aggregate predicted consumable usage by type for a particular enterprise or subset of an enterprise such as a site or campus. The predicted consumable usage is then compared against consumable orders over a comparable period of time. A report is formed listing the predicted values against the actual orders and discrepancies beyond a threshold of twenty percent are flagged and highlighted. The threshold value may be changed according to factors such as types of page printing and other factors. For example, a company known to print mostly white-space documents will use less toner than predicted by an average model. Accordingly, a specific model can be developed as needed with feedback from usage data.

A consumables usage report can be run for a period of time. The report may be for a single business machine or group. Data relating to the consumables used can be extrapolated to synchronize with the meter read data or other usage data for a business machine. Similarly, usage data can be extrapolated to match an inventory reading, incident report or other consumable time frame. A third time reference may be used and both data sets extrapolated. Additionally, a report can calculate and display multiple time periods and overlapping time periods. The report might show one or more of a thirty day, quarter, six month and yearly consumables tracking report for a device or group of devices.

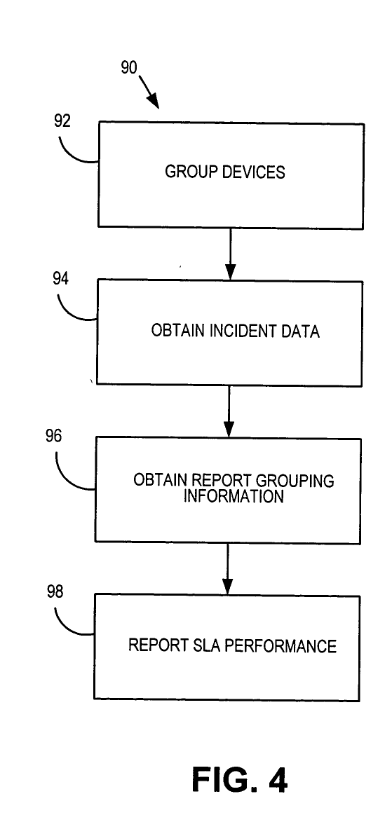

Referring to FIG. 4, another illustrative embodiment of the present application is described. A method for managing the service and maintenance of business machines is described. For example, the system mitigates downtime of business machines such as output devices within a localized site, campus, or enterprise environment. The Asset Management (FAM) software system maintains all aspects of vendor, contract, and service incident management related to the life cycle of the asset. Individual incidents are recorded within the system database and categorized. Based on pre-defined vendor and contract associations, appropriate service providers can be selected through an Add Incident wizard. Additional events and milestones can be logged for each open incident. Specific Service Level Agreement (SLA) milestones are recorded. Escalation processes for categories of incidents are defined and enforced through the GUI.

Utilizing the incident data, hours of operation, and the contracted vendor response time and resolution time, the system displays and trends output device downtime and uptime. This information is aggregated with previously defined periodic charge information to present a total cost of ownership and trend of overall device utilization.

The system provides reports for the identification and trending service-related issues to specific devices, devices grouped by model type, devices grouped by physical location data or devices grouped by organizational data.

The system provides reports that chart device downtime/uptime vs. device utilization data. The system also provides reports that identify under-performing devices. Furthermore, the system provides reports for management, trending and analysis of incident escalation processes. The system provides for efficient management of vendors and contracts.

Referring to FIG. 4, the process 90 begins. In step 92, the process assigns a contract to a group of devices, the contract having parameters including SLA parameters. In step 94, the process obtains incident data. In step 96, device report grouping information is obtained and in step 98, the process reports performance analysis.

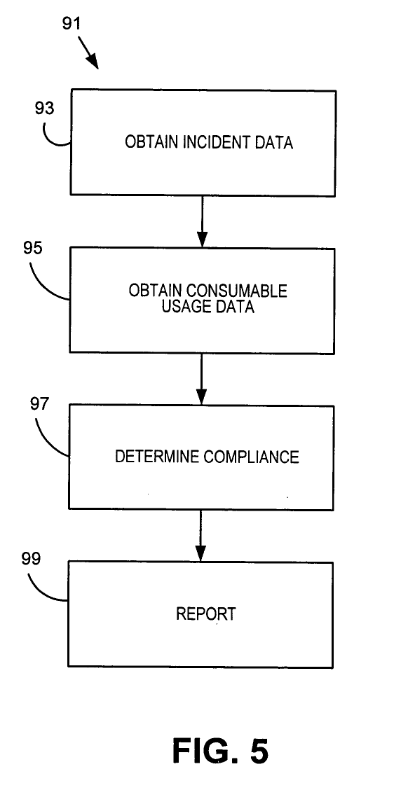

Referring to FIG. 5, a flow chart showing a process for identifying under-performing vendors or key operators according to an illustrative embodiment of the present application. A method to manage vendor and key operator response and resolution effectiveness is described.

The Asset Management system maintains all aspects of vendor, contract, and service incident management related to the life cycle of the asset. Vendors and service providers can be associated to a group or a single asset. Additionally, service-level contracts associate groups of assets with a specific vendor. Key Operators are specific individuals defined within the system that are associated with assets. The key operators perform routine maintenance, such as clearing jams, adding paper, or changing toner. A series of Service Level Agreement (SLA) metrics can be associated to both vendors and key operators.

The system manages the interaction of both vendor service providers and key operators through the Incident Module. The system provides analysis of the vendor and key operator response and resolution effectiveness.

The system provides for identification, trending, and prediction of vendor or key operator effectiveness and provides efficient management of vendors and key operators. Furthermore, the system provides for identification of under-performing vendors or key operators.

Referring to FIG. 5, the process 91 begins. In step 93, the process obtains incident data, the incident data including vendor or key operator data and SLA compliance parameters. In step 95, the process obtains incident SLA requirements data. In step 97, SLA report grouping information is obtained and in step 99, the process reports performance analysis. Accordingly, the system can isolate a particular key operator across all the devices and ignore incident data from a device involving another key operator.

The present application describes illustrative embodiments of a system and method for providing funds accounting including postage payment and verification. The embodiments are illustrative and not intended to present an exhaustive list of possible configurations. Where alternative elements are described, they are understood to fully describe alternative embodiments without repeating common elements whether or not expressly stated to so relate. Similarly, alternatives described for elements used in more than one embodiment are understood to describe alternative embodiments for each of the described embodiments having that element.

The described embodiments are illustrative and the above description may indicate to those skilled in the art additional ways in which the principles of this invention may be used without departing from the spirit of the invention. Accordingly, the scope of each of the claims is not to be limited by the particular embodiments described.

1. A method for tracking consumable usage in business machines comprising:
obtaining business machine usage data;
obtaining consumable usage data;
obtaining consumable benchmark data;
determining consumable usage compliance according to the benchmark data; and
reporting consumable compliance information.

2. The method of claim 1 wherein:
the consumable benchmark data includes nominal and tolerance capacity data associated with business machine usage data;
the consumable usage data includes a number of consumable units used; and
a determination of compliance indicating noncompliance and underutilization of consumables is reported as a potential consumables misuse.

3. The method of claim 1 wherein:
the consumable usage data comprises data over a group of business machines.

4. The method of claim 1 wherein:
the group of business machines is selected according to business machine type.

5. The method of claim 1 wherein:
the group of business machines is selected according to the consumable type.

6. The method of claim 1 wherein:
the group of business machines is selected according to location data.

7. The method of claim 1 wherein:
the group of business machines is selected according to organizational structure data.

8. The method of claim 1 further comprising:
obtaining consumable usage data from a consumable ordering system.

9. The method of claim 1 further comprising:
obtaining consumable usage data from an inventory operation.

10. The method of claim 1 wherein:
the business machine is a printer, the business machine usage data includes pages printed and the consumables data includes a number of toner cartridges orders.

11. A method for tracking individual key operator performance comprising:
obtaining key operator performance data for a plurality of key operators across a fleet of business machines;
obtaining key operator benchmark data relating to acceptable performance levels and tolerances per business machine type;
determining key operator performance levels by selecting operations across the business machine fleet keyed by a key operator identifier; and
reporting key operator performance.
